(19) United States
(12) Patent Application Publication
(10) Pub. No.: US 2010/0250352 A1
(43) Pub. Date: Sep. 30, 2010

(54) System and Method for a Private Civil Security Loyalty Reward Program

(76) Inventor: Barrett H. Moore, Winnetka, IL (US)

Correspondence Address: FITCH EVEN TABIN & FLANNERY, 120 SOUTH LASALLE STREET, SUITE 1600, CHICAGO, IL, 60603-3406, US

(21) Appl. No.: 11/555,589

(22) Filed: Nov. 1, 2006

Related U.S. Application Data
(63) Continuation-in-part of application No. 11/384,037, filed on Mar. 17, 2006, now abandoned.
Application No. 11/384,037 is a continuation-in-part of application No. 11/394,350, filed on Mar. 30, 2006, now abandoned.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006, now abandoned.
Application No. 11/379,929 is a continuation-in-part of application No. 11/381,247, filed on May 2, 2006, now abandoned.
Application No. 11/381,247 is a continuation-in-part of application No. 11/381,257, filed on May 2, 2006, now abandoned.
Application No. 11/381,257 is a continuation-in-part of application No. 11/381,265, filed on May 2, 2006, now abandoned.
Application No. 11/381,265 is a continuation-in-part of application No. 11/381,277, filed on May 2, 2006.
Application No. 11/381,277 is a continuation-in-part of application No. 11/383,022, filed on May 12, 2006, now abandoned.
Application No. 11/383,022 is a continuation-in-part of application No. 11/420,594, filed on May 26, 2006, now abandoned.
Application No. 11/420,594 is a continuation-in-part of application No. 11/421,694, filed on Jun. 1, 2006, now abandoned.
Application No. 11/421,694 is a continuation-in-part of application No. 11/423,594, filed on Jun. 12, 2006, now abandoned.
Application No. 11/423,594 is a continuation-in-part of application No. 11/425,043, filed on Jun. 19, 2006.
Application No. 11/425,043 is a continuation-in-part of application No. 11/426,231, filed on Jun. 23, 2006.
Application No. 11/426,231 is a continuation-in-part of application No. 11/456,472, filed on Jul. 10, 2006, now abandoned.
Application No. 11/456,472 is a continuation-in-part of application No. 11/461,605, filed on Aug. 1, 2006, now abandoned.
Application No. 11/461,605 is a continuation-in-part of application No. 11/461,624, filed on Aug. 1, 2006.
Application No. 11/461,624 is a continuation-in-part of application No. 11/462,795, filed on Aug. 7, 2006.
Application No. 11/462,795 is a continuation-in-part of application No. 11/462,845, filed on Aug. 7, 2006, now abandoned.
Application No. 11/462,845 is a continuation-in-part of application No. 11/464,751, filed on Aug. 15, 2006, now abandoned.
Application No. 11/464,751 is a continuation-in-part of application No. 11/464,764, filed on Aug. 15, 2006, now abandoned.
Application No. 11/464,764 is a continuation-in-part of application No. 11/464,775, filed on Aug. 15, 2006.
Application No. 11/464,775 is a continuation-in-part of application No. 11/464,788, filed on Aug. 15, 2006, now abandoned.
Application No. 11/464,788 is a continuation-in-part of application No. 11/464,799, filed on Aug. 15, 2006, now abandoned.
Application No. 11/464,799 is a continuation-in-part of application No. 11/465,063, filed on Aug. 16, 2006.
Application No. 11/465,063 is a continuation-in-part of application No. 11/466,727, filed on Aug. 23, 2006, now abandoned.
Application No. 11/466,727 is a continuation-in-part of application No. 11/466,953, filed on Aug. 24, 2006, now abandoned.
Application No. 11/466,953 is a continuation-in-part of application No. 11/470,156, filed on Sep. 5, 2006, now abandoned.
Application No. 11/470,156 is a continuation-in-part of application No. 11/531,651, filed on Sep. 13, 2006, now abandoned.
Application No. 11/531,651 is a continuation-in-part of application No. 11/532,461, filed on Sep. 15, 2006.
Application No. 11/532,461 is a continuation-in-part of application No. 11/535,021, filed on Sep. 25, 2006, now abandoned.
Application No. 11/535,021 is a continuation-in-part of application No. 11/535,282, filed on Sep. 26, 2006.
Application No. 11/535,282 is a continuation-in-part of application No. 11/537,469, filed on Sep. 29, 2006.
Application No. 11/537,469 is a continuation-in-part of application No. 11/539,798, filed on Oct. 9, 2006, now abandoned.
Application No. 11/539,798 is a continuation-in-part of application No. 11/539,861, filed on Oct. 9, 2006.
Application No. 11/539,861 is a continuation-in-part of application No. 11/548,191, filed on Oct. 10, 2006, now abandoned.
Application No. 11/548,191 is a continuation-in-part of application No. 11/549,874, filed on Oct. 16, 2006, now abandoned.
Application No. 11/549,874 is a continuation-in-part of application No. 11/550,594, filed on Oct. 18, 2006, now abandoned.
Application No. 11/550,594 is a continuation-in-part of application No. 11/551,083, filed on Oct. 19, 2006.
Application No. 11/551,083 is a continuation of application No. 11/554,452, filed on Oct. 30, 2006.
(60) Provisional application No. 60/820,628, filed on Jul. 28, 2006.
(60) Provisional application No. 60/823,806, filed on Aug. 29, 2006.
(60) Provisional application No. 60/825,524, filed on Sep. 13, 2006.
(60) Provisional application No. 60/825,976, filed on Sep. 18, 2006.
(60) Provisional application No. 60/826,491, filed on Sep. 21, 2006.
(60) Provisional application No. 60/827,591, filed on Sep. 29, 2006.
(60) Provisional application No. 60/827,820, filed on Oct. 2, 2006.
(60) Provisional application No. 60/827,828, filed on Oct. 2, 2006.
(60) Provisional application No. 60/828,341, filed on Oct. 5, 2006.
(60) Provisional application No. 60/828,342, filed on Oct. 5, 2006.
(60) Provisional application No. 60/829,447, filed on Oct. 13, 2006.
(60) Provisional application No. 60/829,779, filed on Oct. 17, 2006.
(60) Provisional application No. 60/862,398, filed on Oct. 20, 2006.
(60) Provisional application No. 60/862,718, filed on Oct. 24, 2006.
(60) Provisional application No. 60/863,469, filed on Oct. 30, 2006.
(60) Provisional application No. 60/863,481, filed on Oct. 30, 2006.

(51) Int. Cl. G06Q 30/00; G06Q 50/00; G06F 21/00; G06F 17/30; G09B 19/00

(52) U.S. Cl. 705/14.16; 705/14.19; 705/14.27; 705/14.28; 705/14.31; 705/14.33; 726/2; 707/802; 434/236; 707/E17.005

(57) ABSTRACT

A private civil security loyalty reward program allows access to a user.

### CROSS REFERENCES TO RELATED APPLICATIONS

This application claims the benefit of the filing date of U.S. provisional application Nos. 60/820,628 filed on Jul. 28, 2006, 60/823,806 filed on Aug. 29, 2006, 60/825,524 filed on Sep. 13, 2006, 60/825,976 filed on Sep. 18, 2006, 60/826,491 filed on Sep. 29, 2006, 60/827,591 filed on Sep. 29, 2006, 60/827,820 filed on Oct. 2, 2006, 60/827,828 filed on Oct. 2, 2006, 60/828,341 filed on Oct. 5, 2006, 60/828,342 filed on Oct. 5, 2006, 60/829,447 filed on Oct. 13, 2006, 60/829,779 filed on Oct. 17, 2006, 60/862,398 filed on Oct. 20, 2006, 60/862,718 filed on Oct. 24, 2006, 60/863,469 filed on Oct. 30, 2006, 60/863,481 filed on Oct. 30, 2006, which are hereby incorporated in their entirety herein.

This comprises a continuation-in-part of each of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265;

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624;

SUBSCRIPTION-BASED INTERMEDIATE SHORT-TERM EMERGENCY SHELTER METHOD as filed on Aug. 7, 2006 and having application Ser. No. 11/462,795;

SUBSCRIPTION-BASED CATASTROPHE-TRIGGERED RESCUE SERVICES FACILITATION METHOD USING WIRELESS LOCATION INFORMATION as filed on Aug. 7, 2006 and having application Ser. No. 11/462,845;

PRIVATELY PROVISIONED SURVIVAL SUPPLIES DELIVERY METHOD as filed on Aug. 15, 2006 and having application Ser. No. 11/464,751;

PRIVATELY PROVISIONED SURVIVAL SUPPLIES SUB-UNIT-BASED DELIVERY METHOD as filed on Aug. 15, 2006 and having application Ser. No. 11/464,764;

PRIVATELY PROVISIONED SURVIVAL SUPPLIES ACQUISITION METHOD as filed on Aug. 15, 2006 and having application Ser. No. 11/464,775;

PRIVATELY PROVISIONED SURVIVAL SUPPLIES CONTENT ACQUISITION METHOD as filed on Aug. 15, 2006 and having application Ser. No. 11/464,788;

METHOD TO PRIVATELY PROVISION SURVIVAL SUPPLIES THAT INCLUDE THIRD PARTY ITEMS as filed on Aug. 15, 2006 and having application Ser. No. 11/464,799;

WASTE DISPOSAL DEVICE as filed on Aug. 16, 2006 and having application Ser. No. 11/465,063;

SUBSCRIPTION-BASED PRIVATE CIVIL SECURITY RESOURCE CUSTOMIZATION METHOD as filed on Aug. 23, 2006 and having application Ser. No. 11/466,727;

PREMIUM-BASED PRIVATE CIVIL SECURITY POLICY METHODS as filed on Aug. 24, 2006 and having application Ser. No. 11/466,953;

SUBSCRIPTION-BASED MOBILE SHELTER METHOD as filed on Sep. 5, 2006 and having application Ser. No. 11/470,156;

METHOD OF PROVIDING A FLOATING LIFE-SUSTAINING FACILITY as filed on Sep. 13, 2006 and having application Ser. No. 11/531,651;

PRIVATELY PROVISIONED SUB-UNIT-BASED SURVIVAL SUPPLIES PROVISIONING METHOD as filed on Sep. 15, 2006 and having application Ser. No. 11/532,461;

PRIVATELY PROVISIONED INTERLOCKING SUB-UNIT-BASED SURVIVAL SUPPLIES PROVISIONING METHOD as filed on Sep. 25, 2006 and having application Ser. No. 11/535,021;

RESOURCE CONTAINER AND POSITIONING METHOD AND APPARATUS as filed on Sep. 26, 2006 and having application Ser. No. 11/535,282;

PUBLICLY-FUNDED PRIVATELY FACILITATED ACCESS TO SURVIVAL RESOURCES METHOD as filed on Sep. 29, 2006 and having application Ser. No. 11/537,469;

ELECTRICITY PROVIDING PRIVATELY PROVISIONED SUBSCRIPTION-BASED SURVIVAL SUPPLY UNIT METHOD AND APPARATUS as filed on Oct. 9, 2006 and having application Ser. No. 11/539,798;

PREMIUM-BASED CIVILLY-CATASTROPHIC EVENT THREAT ASSESSMENT as filed on Oct. 9, 2006 and having application Ser. No. 11/539,861;

PRIVATELY MANAGED ENTERTAINMENT AND RECREATION SUPPLIES PROVISIONING METHOD as filed on Oct. 10, 2006 and having application Ser. No. 11/548,191;

METHOD TO FACILITATE PROVIDING ACCESS TO A PLURALITY OF PRIVATE CIVIL SECURITY RESOURCE as filed on Oct. 16, 2006 and having application Ser. No. 11/549,874;

METHOD OF PROVIDING BEARER CERTIFICATES FOR PRIVATE CIVIL SECURITY BENEFITS as filed on Oct. 18, 2006 and having application Ser. No. 11/550,594;

METHOD FOR CIVILLY-CATASTROPHIC EVENT-BASED TRANSPORT SERVICE AND VEHICLES THEREFOR as filed on Oct. 19, 2006 and having application Ser. No. 11/551,083;

METHOD FOR PROVIDING private civil security SERVICES BUNDLED WITH second party PRODUCTS as filed on Oct. 30, 2006 and having application Ser. No. 11/554,452;

the contents of each of which are fully incorporated herein by this reference.

### FIELD OF THE INVENTION

The field of the invention relates to private civil security resources and providing these resources to users.

### BACKGROUND OF THE INVENTION

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to transportation infrastructure such as roads, bridges, railways, and so forth that facilitate the inexpensive and rapid movement of sometimes perishable goods from source to consumer; communications infrastructure such as telephones, television, radio, and the Internet that facilitate the inexpensive and rapid sharing of news, advice, information, and entertainment; and the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swatch of a given civil community. Any number of natural and/or non-naturally-caused events can sufficiently disrupt society's infrastructure and ability to provide one or more life-sustaining resources such as water, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

Such insights, of course, are not particularly new. Civil preparedness shortcomings occasionally attract public attention, and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk survival (let alone the comfort) of their citizens in the face of most civilly-catastrophic events. On the other hand, attempting to take responsible actions to reasonably ensure one's own safety and security can become, in and of itself, nearly a full-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

### BRIEF DESCRIPTION OF THE DRAWINGS

The above needs are at least partially met through provision of system and method of providing a private civil security loyalty reward program as described in the following detailed description in conjunction with the drawings, wherein:

FIG. 1 is a block diagram of a system for providing a private civil security loyalty reward program according to various embodiments of the present invention;

FIG. 2 is a block diagram of a user interface according to various embodiments of the present invention;

FIG. 3 is a diagram showing different user interactions with a private civil security loyalty reward program according to various embodiments of the present invention;

FIG. 4 is a block diagram of a redemption resource according to various embodiments of the present invention;

FIG. 5 is a block diagram of an accumulation resource according to various embodiments of the present invention;

FIG. 6 is a block diagram of an information provision resource according to various embodiments of the present invention;

FIG. 7 is a flowchart of one example of the operation of a private civil security loyalty reward program according to various embodiments of the present invention;

FIG. 8 is a block diagram of one example of a mapping relationship according to various embodiments of the present invention; and

FIG. 9 is a flowchart of another approach for operating a private civil security loyalty reward program according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A private civil security loyalty reward program allows authorized beneficiaries to accumulate and/or redeem loyalty rewards metrics (e.g., rewards points) for private civil security rewards. The approaches described herein provide for various types of interactions with the program and allow the program to provide different types of services to authorized beneficiaries. In so doing, the private civil security loyalty reward program promotes increased interest, participation, and/or sales of private civil security services and/or products.

In some of these embodiments, a private civil security loyalty reward program is provided. It is determined whether a user is an authorized beneficiary of the program. When the user is an authorized beneficiary, the user is allowed access to the private civil security loyalty reward program.

Furthermore, redeemable rewards metrics may be received at the private civil security loyalty reward program from authorized beneficiaries. In one approach, the redeemable rewards metrics are associated with an external loyalty rewards program. In this case, the external loyalty rewards program may be an airline frequent flier program, a credit card usage program, a retail business loyalty program, a hotel loyalty program, a car rental loyalty program, or a restaurant frequent diner loyalty program, to note but a few examples in this regard. The redeemable rewards metrics may be redeemed at the private civil security loyalty program for one or more private civil security loyalty rewards. The rewards may include a wide variety of items or services such as private civil security subscriptions, private civil security benefits, private civil security products, private civil security services, discounts, cash rewards, promotional products, extensions of time for service memberships, increases in volume of private civil security elements, increases in the quality of a private civil security elements, amounts of training, barter items, or amounts of instructor-led training

In other approaches, the received redeemable rewards metric may be associated with the interaction of the user with at least one private civil security element. The interaction may be related to a wide variety of actions such as the purchase of a private civil security subscription, the purchase of a private civil security benefit, the purchase of a private civil security product, or the purchase of a private civil security service. Other examples of interactions are possible.

When received by the private civil security loyalty reward program, the redeemable rewards metric associated with the interaction of the user with the private civil security element may be redeemed for one or more private civil security loyalty rewards. As mentioned, the private civil security loyalty reward may be chosen from a wide variety of products or services such as private civil security subscriptions, private civil security benefits, private civil security products, private civil security services, discounts, cash rewards, promotional products, barter items, or benefits from external loyalty rewards programs. Other examples of rewards are possible.

In still other approaches, the redeemable rewards metric includes an indication of an enrollment in a private civil security program training program. In one example, the private civil security loyalty reward training program provides instructions regarding how to interact with one or more private civil security elements. The instructions themselves may relate to training topics such as medical assistance skills, food preparation skills, farming skills, botany skills, carpentry skills, communications skills, computer skills, engineering skills, survival skills, nuclear, biological, and chemical threat mitigation skills, transportation skills, evacuation skills, shelter (construction, maintenance, and/or habitation) skills, navigation skills, civil defense skills, metal fabrication skills, hunting skills, fishing skills, field dressing of game skills, and business skills, to again note but a few relevant examples. Other examples of training topics are possible.

In yet another approach, the redeemable rewards metric is an indication of an initial usage of one or more private civil security elements by the user. In this case, the redeemable rewards metric may be determined based upon a wide variety of factors such as a percentage of receipts received that are associated with subsequent subscribers (as compared to the user). The determination as to whether the user is an initial subscriber may be based upon one or more criteria such as the usage of the private civil security element within a predetermined window of time, or the maximum aggregate value of receipts associated with subsequent subscriptions.

In other approaches, the redeemable rewards metric may be an indication of one or more testimonials for private civil security products or services made by the user. The testimonials may be made orally, in writing, or in any other form.

In still other examples, the redeemable rewards metric may be an indication of one or more referrals made by the user. In the case of referrals, the value of the redeemable rewards metric may be determined by criteria such as the amount or number of referrals, the associated monetary value of the referrals, the nature of services associated with the referrals, or the geographic area associated with the referrals.

Other features may also be supported by the system. For example, the amount or value of the accumulated redeemable rewards metric associated with a user may be adjusted appropriately in a time of need. In one specific example, when a time of need exists (e.g., during a civil security crisis), then the amount or value of the redeemable rewards metric might be increased.

Different service levels may also be provided to the user. In this regard, better or improved service levels may be obtained through a monetary payment or the previous usage of the private civil security loyalty reward program. Each of the service levels may have associated characteristics or benefits such as a length of service, an amount of available customer support, a quality of service, or a type of service.

In still other approaches, information associated with the private civil security loyalty reward program may be maintained in a database. For instance, account balance or user interaction information may be maintained in the database of private civil security loyalty reward program beneficiaries. Some or all of the portions of contents of the database may be made available to outside entities. The outside entities may be outside corporations, non-beneficiary individuals, not-for-profit entities, or government entities. The database may also be accessed to in order to prepare account statements for users. In addition, the database may store the addresses of users and these addresses may be used to send catalogs of services/products to users. Furthermore, the database may store catalogs or other promotional materials electronically such that these electronic documents are available to users via email and/or the Internet.

A private civil security network may also be provided and associated with the private civil security loyalty reward program. Individuals and/or organizations may belong to the network. In some examples, authorized beneficiaries may belong to the network, while, in other examples, the authorized beneficiary may not be a member of the network. Membership in the network may itself be a reward. In one example of this approach, the redeemable awards metric may also be redeemed for network membership when the redeemable rewards metric is accumulated via an external loyalty rewards program (and the authorized beneficiary is not a network member).

Thus, a private civil security loyalty reward program is provided. This program allows rewards metrics to be accumulated and redeemed for rewards. The private civil security loyalty reward program promotes a higher degree of participation in private civil security products or services. More specifically, the private civil security loyalty reward program motivates users and subscribers to purchase or subscribe to many offered products and services. Moreover, the private civil security loyalty reward program is easy and cost effective to use and can promote a higher degree of user satisfaction with the private civil security products and services.

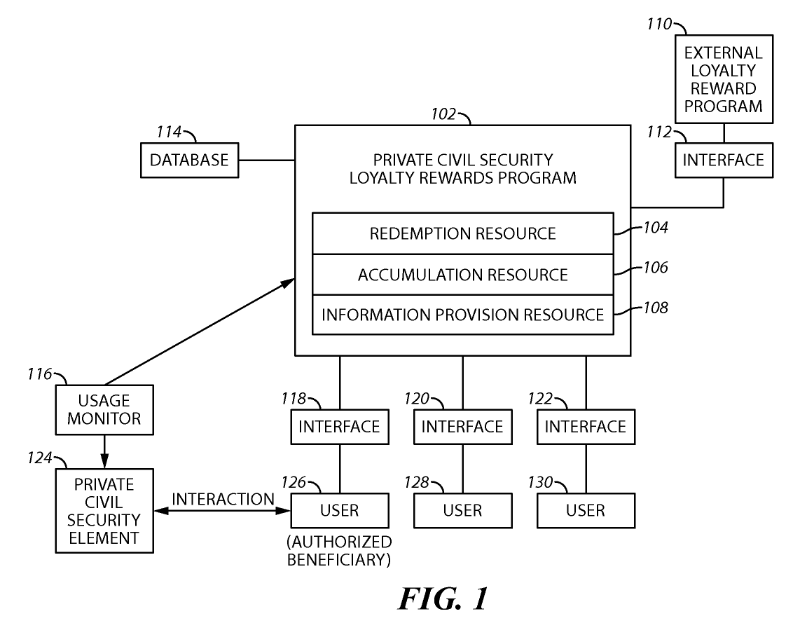

Referring now to FIG. 1, one example of a private civil security loyalty reward program 102 and interactions with the program 102 are described. The private civil security loyalty reward program 102 includes a redemption resource 104, an accumulation resource 106, and an information provision resource 108. The private civil security loyalty reward program 102 is coupled to and interacts with a database 114, interfaces 112, 118, 120, and 122, and a usage monitor 116. A first interface 112 is coupled to and interacts with an external loyalty rewards program 110. The remaining interfaces 118, 120, and 122 interact with corresponding users 126, 128, and 130, respectively. The usage monitor 116 is also coupled to and interacts with a private civil security element 124.

The metrics may be of any form, structure, or representation. For example, the metrics may be points, dollar amounts, values representing time, values representing usage, or any other value representing program participation. Other examples of metrics are possible.

It will be appreciated that many of the above-mentioned elements as well as the other elements described within this Specification may be implemented in computer hardware, computer software, or a combination of computer hardware or software. For example, the private civil security loyalty reward program 102 and its elements may be implemented using a microprocessor or other processing devices supporting various combinations of software elements in various programming languages.

The redemption resource 104 (described in greater detail below with respect to FIG. 4) receives rewards metrics, determines rewards for these metrics, and facilitates the provision of the rewards to authorized beneficiaries. The rewards metrics (e.g., rewards points) may be received from a variety of sources. For example, the metrics may be received from the external loyalty rewards program 110. In this example, an arrangement may be made between the provider of the external loyalty rewards program 110 and the private civil security loyalty reward program 102 to permit access for holders of metrics from the external loyalty rewards program 110; to allocate the external metrics to corresponding metrics of the private civil security loyalty reward program 102; and to allow redemption of the converted metrics by the private civil security loyalty reward program 102. Program members can mix and match metric (e.g., point) awards to obtain different awards levels.

In another example, the rewards metrics may represent usage of the private civil security element 124 (e.g., purchase of a product or subscription to a service). In this case, the rewards metrics may be received directly from one of the users 126, 128, or 130; from the usage monitor 116; or may have been stored and retrieved from the database 114.

In one approach, the redemption resource 104 applies a mapping relationship to the metrics to determine the reward. The mapping relationship receives a metric value and maps it to a reward. The redemption resource 104 may thereafter facilitate obtaining the reward, either supplying it directly to the user, ordering the reward from an outside source, or in some other way making the award available to the user.

The rewards may include a wide variety of products and/or services such as private civil security subscriptions, private civil security benefits, private civil security products, private civil security services, discounts, cash rewards, promotional products, extensions of time for service memberships, increases in volume of private civil security elements, increases in quality of a private civil security elements, amounts of training, barter items, or amounts of instructor-led training. Non-civil security products or services may also be used as rewards. Additional examples of rewards are possible.

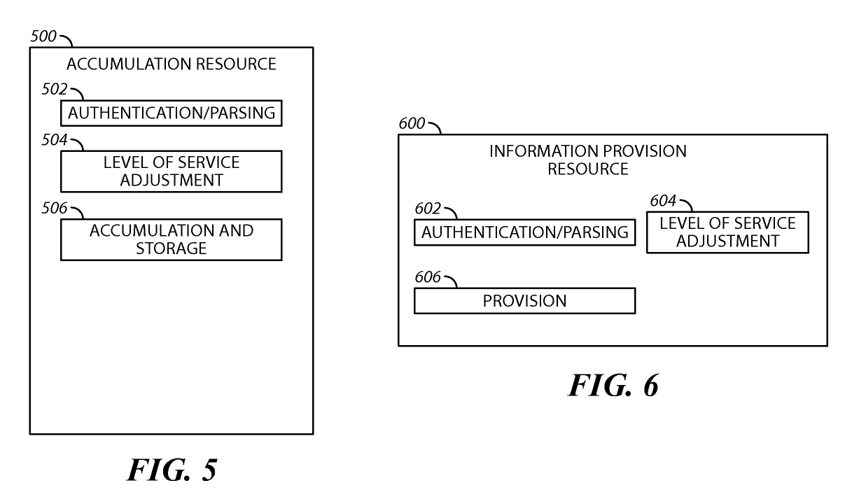

The accumulation resource 106 (described in greater detail below with respect to FIG. 5) receives rewards metrics and may convert them into a form usable by the private civil security loyalty reward program 102. Interactions with the accumulation resource may be in any from such as by mail, by computer interface, in person, or over a telephone connection.

The accumulation resource 106, after verifying that a user is an authorized beneficiary, identifies the metrics and performs any conversions and/or metric processing needed. For instance, the rewards metrics may be mailed to the accumulation resource 106 and, consequently, the rewards metrics may need to be identified and obtained from the mailing. In this example, obtaining the metric from the mailing may be accomplished by an automatic scan of the mailing or, alternatively, by a manual human inspection of the mailing. As another example in this regard, the metric may assume the form of an optical code such as a mailing (such as a two or three dimensional optical code as is known in the art); in such a case, obtaining the metric can comprise reading that optical code using a corresponding reader.

After the processing of the metric is complete, the accumulation resource 106 may access the user's account in the database 114 and adjust the account balance as required. For instance, after the metric is obtained from the mailing, the metric may be entered automatically into the database 114 (or the stored, accumulated value of the metric in the database 114 adjusted based upon the amount of the metric) by a computer program or manually via a human operator using a personal computing device or other appropriate interface.

The information provision resource 108 (described in greater detail below with respect to FIG. 6) processes information requests from authorized beneficiaries. For instance, it parses requests from the user, receives data from the database 114, and sends the information (for example, in the form of reports) to the requestor.

The database 114 may be any type of information store or data storage device. The database 114 may include information concerning the private civil security loyalty reward program 102 such as the accumulated metrics (e.g., points) of users. Other information may be included in the database 114 such as the usage patterns of authorized beneficiaries, statistics concerning program usage, the addresses or other contact information of authorized beneficiaries, information concerning the rewards such as catalogs or the like.

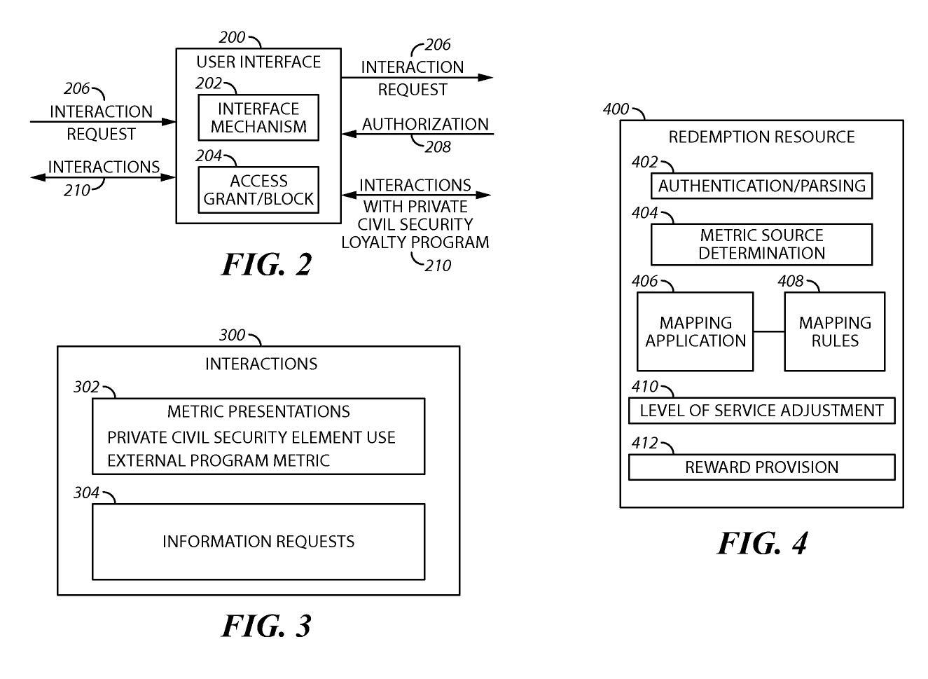

The interfaces 112, 118, 120, and 122 (described in greater detail with respect to FIG. 2 below) provide access for the users 126, 128, and 130 and the external loyalty rewards program 110 to the private civil security reward program 102. In this regard, the interfaces 112, 118, 120, and 122 include an access mechanism. The access mechanism may utilize any type of technology or combination of technologies such as telephone lines, wireless links, mail, package delivery services, human voice, or in-person exchanges.

In one example, any of the interfaces can be an Internet or web interface. In this case, the web interface may performs a function such as allowing a user to audit information concerning a membership; allowing a user to review account balances; allowing a user to review reward levels; allowing a user to request rewards; allowing a user to ask questions; allowing a user to access a frequently asked question page; allowing a user to enter referral information; allowing a user to perform a management functions. Other examples are possible.

The external loyalty rewards program 110 may be any type of loyalty program that supplies corresponding metrics. For example, the external loyalty rewards program 110 may be an airline frequent flier program, a credit card usage program, a retail business loyalty program, a hotel loyalty program, a car rental loyalty program, or a restaurant frequent diner loyalty program. Other examples of external loyalty rewards programs are possible.

The private civil security element 124 may be a private civil security subscription, a private civil security benefit, a private civil security product, or a private civil security service. Using these examples, the interaction between the user and the element 124 may consist of the purchase of a private civil security subscription, the purchase of a private civil security benefit, the purchase of a private civil security product, or the purchase of a private civil security service.

The usage monitor 116 monitors the usage of the private civil security element by any of the users. Reports may be formed and sent to the private civil security loyalty reward program 102 from the usage monitor 116. For example, when a private civil security product is purchased, an indication of the purchase may be sent by the usage monitor 116 to the private civil security loyalty reward program 102. Alternatively, the users 126, 128, or 130 may directly report their usage of the element 124 to the private civil security loyalty reward program 102. The reporting may be over any type of access medium such as over phone lines, computer lines, by mail, by a package delivery service, or by an in-person exchange.

The users 126, 128, and 130 may be any type of human or non-human user. For example, the users 126, 128, or 130 may be persons, businesses, not-for-profit entities, or government entities. Other examples of users are possible.

In one example of the operation of the system of FIG. 1, the private civil security loyalty reward program 102 determines whether one of the users 126, 128, or 130, or the external loyalty rewards program 110 is an authorized beneficiary of the private civil security loyalty reward program 102. When the user is an authorized beneficiary, the user 126, 128, or 130, or the external loyalty rewards program 110 is allowed access to the private civil security loyalty reward program 102.

A redeemable rewards metric may be received at the private civil security loyalty reward program 102 from any of the authorized beneficiaries (e.g., the user 126, 128, or 130, or external loyalty rewards program 110). In one approach, the redeemable rewards metric is associated with the external loyalty rewards program 110. The redeemable rewards metric may be redeemed at the private civil security loyalty program 102 for one or more private civil security loyalty rewards. As mentioned, the rewards may include a wide variety of products and/or services such as private civil security subscriptions, private civil security benefits, private civil security products, private civil security services, discounts, cash rewards, promotional products, extensions of time for service memberships, increases in volume of private civil security elements, increases in quality of a private civil security elements, amounts of training, barter items, or amounts of instructor-led training. Other examples of rewards are possible.

In other approaches, the received redeemable rewards metric may be associated with the interaction of one or more of the users 126, 128 or 130 with the civil security element 124. As mentioned, the interaction may be related to a variety of actions such as the purchase of a private civil security subscription, the purchase of a private civil security benefit, the purchase of a private civil security product, or the purchase of a private civil security service.

When received at the private civil security loyalty reward program 102, the redeemable rewards metric may be processed and stored (by the accumulation resource 106) in the database 114 and may be redeemed (by the redemption resource 104) for one or more private civil security loyalty rewards.

In still other approaches, the redeemable rewards metric received by the private civil security loyalty reward program 102 is an indication of an enrollment in a private civil security program training program. The private civil security loyalty reward training program provides instructions as how to interact with the private civil security element 124. The instructions may relate to a training topic such as medical assistance skills, food preparation skills, farming skills, botany skills, carpentry skills, communications skills, computer skills, engineering skills, survival skills, nuclear, biological, and chemical threat mitigation skills, transportation skills, evacuations skills, shelter skills, navigation skills, civil defense skills, metal fabrication skills, hunting skills, fishing skills, field dressing of game skills, and business. The skills may be then used before, during, and/or after a civilly-catastrophic event to assist the civil service provider and facilitate the successful execution of the services of the provider.

In another approach, a subscriber that participates in a training program can be awarded a first set of metrics (e.g., points) or discounts upon completion of the training course, and can then optionally be provided with additional metrics or discounts at the time the trained subscriber actually uses their training and skills to assist the civil security provider. Such an incentive structure will not only motivate an encourage subscribers to take training courses, but will encourage a trained subscriber to use the skills and training during a time of need.

In another example, the redeemable rewards metric received by the private civil security loyalty reward program 102 is an indication of an initial usage of the private civil security element 124 by one of the users 126, 128, or 130. The redeemable rewards metric for the user may be determined based at least in part upon a percentage of the receipts from subsequent subscribers. Whether one of the users 126, 128, or 130 is an initial subscriber may based upon criteria such as the usage of the private civil security element 124 within a predetermined window of time or the maximum aggregate value of receipts associated with subsequent subscriptions.

In other approaches, the redeemable rewards metric received by the private civil security loyalty reward program 102 may be an indication of one or more testimonials made by one or more of the users 126, 128, or 130. The testimonials may be made orally, in writing, or any other form.

In still other examples, the redeemable rewards metric may be an indication of one or more referrals from one or more of the users 126, 128, or 130. In the case of referrals, the value of the redeemable rewards metric associated with the referral may be determined by criteria such as the amount of the referral, the associated monetary value of the referral, the nature of services associated with the referral, or the geographic area associated with the referral.

Other features may also be provided by the private civil security loyalty reward program 102. For example, the amount of the redeemable rewards metric associated with one of the users 126, 128, or 130 may be adjusted in a time of need. More specifically, to take one example, this amount may be adjusted upward in a crisis or adjusted downward in times when no crisis exists.

A number of different levels of service may be provided to the users 126, 128, or 130. In this regard, the monetary payments of users or the previous usage of the private civil security loyalty reward program 102 may permit users to obtain premium or upgraded service levels. Each of the service levels may have associated characteristics such as a length of service, an amount of available customer support, a quality of service, and/or a type of service. The characteristics may be adjusted amongst service levels so that higher service levels have improved or more highly-valued characteristics while lower service levels have basic or less highly-valued characteristics.

As mentioned, information associated with user interactions with the private civil security loyalty reward program 102 may be maintained in the database 114. Some or all of the portions of contents of the database 114 may be made available to outside entities. The outside entities may be outside corporations, non-beneficiary individuals, not-for-profit entities, or government entities. Other examples of outside entities are possible. Statements (e.g., including account balances or other account information) or catalogs of services/products may be provided to the users 126, 128, or 130, the outside entities, the external loyalty reward program 110, or others. These may be provided on a request-by-request basis, at specific intervals, or at the occurrence of specific events (e.g., sales events, promotional events).

A private civil security network may also be provided and associated with the private civil security loyalty reward program 102. Individuals and/or organizations may belong to the network. In some examples, authorized beneficiaries may belong to the network, while, in other examples, the authorized beneficiary may not be a member of the network. Membership in the network may itself be a reward. In one example of this approach, the redeemable awards metric may also be redeemed for network membership when the redeemable rewards metric is accumulated via an external loyalty rewards program (and the authorized beneficiary is not a network member).

Referring now to FIG. 2, one example of a user interface 200 is described. The user interface 200 includes an interface mechanism 202 and an access grant/block element 204.

The interface mechanism 202 may utilize any approach, technology, or combination of approaches/technologies to provide a communication path/mechanism between the user and the private civil security loyalty reward program. For example, the interface mechanism may utilize any type of technology such as telephone lines, wireless links, mail, package delivery services, or in-person exchanges (i.e., using the human voice to communicate). Other examples of interface mechanisms are possible.

The access grant/block element 204 allows or blocks attempts to access the private civil security loyalty reward program based upon whether the private civil security loyalty reward program authorizes access by the user. For example, an interaction request 206 may be received from a user by the interface 200 and passed on to the private civil security loyalty reward program. The private civil security loyalty reward program returns an authorization (or, alternatively, a denial of access) to the user interface 200. Based upon the authorization (or denial), interactions 210 (e.g., presentations of metrics, status requests) are allowed (or access is prohibited) between the user and the private civil security loyalty reward program using the interface mechanism 202.

Referring now to FIG. 3, one example of different types of interactions between users and the private civil security loyalty reward program are described. The interactions 300 may include metric presentations 302 or information requests 304.

The metric presentations 302 may include presentations of metrics from external loyalty rewards programs or relate to the usage of a private civil security element. The metric presentations 302 may be made using any medium (e.g., via telephone, by paper, in person, or via the Internet). The information requests 304 may be any type of message requesting information concerning the metrics, user interactions, rewards, loyalty program rules and background information, or other types of information associated with the private civil security loyalty reward program. In one example, the information requests 304 are requests to obtain account information (e.g., balance information) for an authorized beneficiary. Other examples of metric presentations and information requests are possible.

Referring now to FIG. 4, one example of a redemption resource 400 is described. The redemption resource 400 includes an authentication/parsing element 402, a metric source determination element 404, a mapping application 406, mapping rules 408, a level of service adjustment element 410, and a reward provision element 412.

The authentication/parsing element 402 receives a request, parses the request, and authenticates that the request is from an authorized beneficiary. For example, the authentication/parsing element 402 may receive a request to access the private civil security loyalty reward program and determine the identity of the user making the request. The authentication/parsing element 402 then compares the identity to a list of authorized beneficiaries. If a match exists, then access may be granted and, if a match does not exist, access is denied.

The metric source determination element 404 determines whether the metric received relates to the usage of a private civil security element or whether the received metric is from an external loyalty rewards program. Depending upon the source of the metric, different processing functions may be performed on the metric and different actions may be performed. In one example, different types of rewards may be awarded for metrics received from external loyalty rewards programs as compared to metrics that are associated with private civil security element usage. In another example, raw metrics received from external loyalty rewards programs may need to be converted to metrics that correspond to the form of the metrics used within the private civil security loyalty reward program.

The mapping application 406 applies a set of mapping rules to the metrics to obtain a reward. More specifically, the mapping application 406 obtains the mapping rules 408 and the metric and performs a mapping of the metric using the mapping rules 408 to obtain a reward.

The mapping rules 408 are rules that relate a metric quantity (or value) or range of quantities (or values) to one or more rewards. In one example, the mapping rules 408 may be stored as a table and include one column as a range of reward points and the other column a reward (or rewards) corresponding to the reward point range. It will be appreciated that the mapping rules may be implemented as any data and/or programming structure.

The level of service adjustment element 410 adjusts the operation of the redemption resource 400 to take into account a level of service associated with an authorized beneficiary. As mentioned, a user may be entitled to particular service levels based upon payment or usage levels. For example, a higher service level may entitle the user to more rewards choices or faster reward processing.

The reward provision element 412 facilitates the provision of rewards to authorized beneficiaries. In one example, the reward provision element 412 may include or utilize the entire infrastructure (reward, warehouse, transportation structure) needed to provide the reward to the authorized beneficiary. In another example, the reward provision element may be merely instructions (e.g., a computer message or email specifying the reward and the address of the authorized beneficiary) sent to a distribution center instructing the distribution center to send a reward to the authorized beneficiary at the address indicated in the message. As can be appreciated, various elements, processes, and approaches can be incorporated into and comprise the reward provision element 412.

Referring now to FIG. 5, one example of an accumulation resource 500 is described. The accumulation resource 500 includes an authentication/parsing element 502, level of service adjustment element 504, and an accumulation and storage element 506. The accumulation resource 500 may interact with a redemption resource (e.g., redemption resource 104 or 400) in order to redeem metrics for rewards.

The authentication/parsing element 502 receives a request, parses the request, and authenticates that the request is from an authorized beneficiary. For example, the authentication/parsing element 502 may receive a request to access the private civil security loyalty reward program and determine the identity of the user making the request. The authentication/parsing element 502 then compares the identity to a list of authorized beneficiaries. If a match exists, then access may be granted and, if a match does not exist, access may be denied.

The level of service adjustment element 504 adjusts the operation of the accumulation resource 500 in order to take into account a level of service associated with an authorized beneficiary. In one example, a higher level of service may entitle the user to faster service or greater levels of customer support.

The accumulation and storage element 506 accumulates rewards metrics and forwards the accumulated awards to a database for storage. In this regard, the accumulation and storage element may process raw reward metric information and convert this information into a usable form. For instance, if the rewards metrics are received by mail, the mail may be automatically scanned and the metric determined from the scan. In another example, the accumulation and storage element may receive electronic data (e.g., transactional data from credit card usage) and convert the data into a usable reward metric value.

Referring now to FIG. 6, one example of an information provision resource 600 is described. The information provision resource 600 includes an authentication/parsing element 602, level of service adjustment element 604, and a provision element 608.

The authentication/parsing element 602 receives a request, parses the request, and, if needed, authenticates that the request is from an authorized beneficiary. For example, the authentication/parsing element 602 may receive a request to access information in a database associated with the private civil security loyalty reward program and determine the identity of the user making the request. The authentication/parsing element 602 then compares the identity to a list of authorized beneficiaries. If a match exists, then access may be granted and if a match does not exist, access may be denied.

In another example, the authentication/parsing element 602 may receive a request to send information concerning the rewards program to an interested party. In this case, no authorization is needed and the information is automatically sent.

The authentication/parsing element 602 may also determine the nature of the request made by a user. For instance, the user may make a request for an account balance, to have a report mailed to the user, for a catalog of rewards, or for other types of products or services. Based upon the nature of the request, an appropriate action may be taken.

The level of service adjustment element 604 adjusts the operation of the redemption resource to take into account a level of service associated with an authorized beneficiary. The provision element 606 receives a parsed request and processes the request. For example, if the request is for an account balance, the provision element 606 obtains the account information from a database, formats the information in an appropriate format (e.g., a paper report or an electronic document), and presents or facilitates the presentation of the information to the user (e.g., mails the information or sends the information via email).

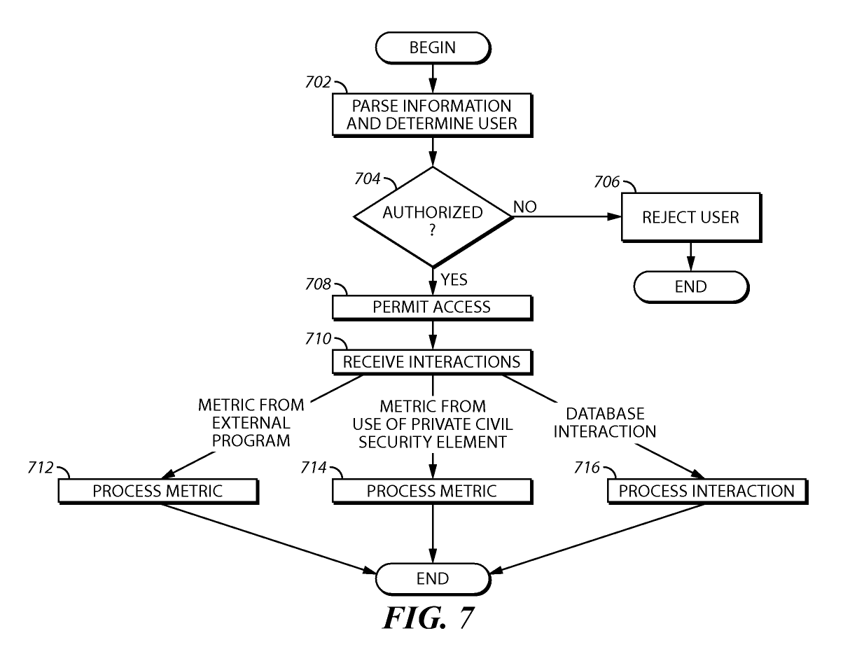

Referring now to FIG. 7, one example of an approach for providing a private civil security loyalty reward program is described. At step 702, a request for access is received and parsed to determine the identity of user. At step 704, it is determined whether the user is an authorized beneficiary. If the answer at step 704 is negative, at step 706, access to the private civil security loyalty reward program by the user is denied. (As one optional approach in this regard, a negative finding in this regard can also serve to prompt a recruitment process to seek to interest the individual in question in becoming an authorized beneficiary). If the answer at step 704 is affirmative, execution continues at step 708. Alternatively for some interactions (e.g., the sending of general information or catalogs associated with the private civil security loyalty reward program) no authorization may be needed and steps 704 and 706 may be omitted.

At step 708, access is permitted. In this case, the user is permitted to present reward metrics to the system or access information regarding the user's account. The amount of access and the services provided may depend upon a level of service associated with the user. In addition, the amount of access may depend upon the identity of the user.

At step 710, interactions associated with the user are received. For example, a metric from an external loyalty rewards program may be received. In another example, a metric associated with the usage of a private civil security element is received. In still another example, a request for information is received. Depending upon the interaction received, one of three steps 712, 714, or 716 is performed.

At step 712, a metric from an external loyalty rewards program is received and this metric is processed. For example, the amount may be identified, converted into a metric applicable to the private civil security reward program, a reward determined, and the reward provided to the user. Any of these actions may be adjusted by a service level associated with the user.

At step 714, a metric associated with the usage of a private civil security element is received and this metric is processed. For example, the amount of the metric may be identified, any conversions or adjustments performed, a reward determined, and the reward provided to the user. Any of these actions may be adjusted by a service level associated with the user.

At step 716, a request for information is received and this request is processed. For example, a request for an account balance may be received and the account balance determined and provided to the requestor.

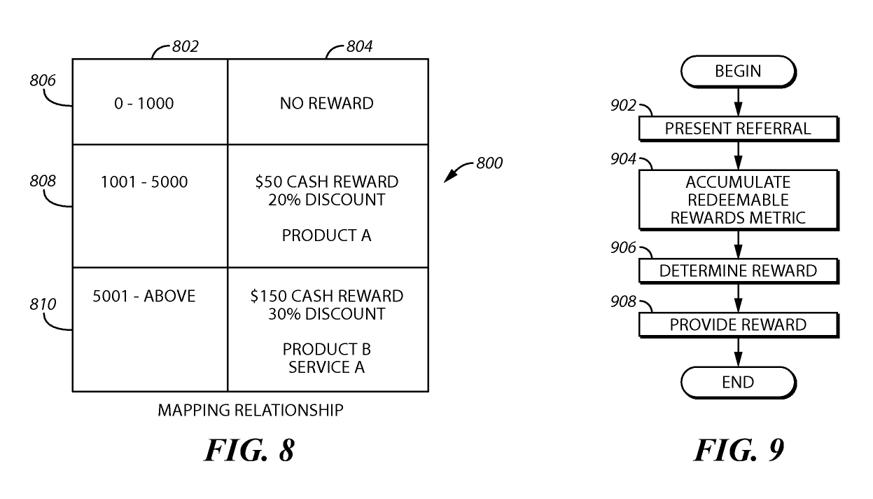

Referring now to FIG. 8, one example of a mapping relationship 800 is described. The mapping relationship receives as input a rewards metric (e.g., points) and converts the metric into a reward. In this example, a first column 802 provides a point range and a second column presents a reward. It will be appreciated that although the data structure here is in the form of a table, any sort of data structure or programming approach can be utilized.

In this example, a first row 806 indicates that 0-1000 points receives no reward. A second row 808 indicates 1001-5000 points entitles the beneficiary to a $50 cash reward, a 20% discount in services or products, or a free product A. A third row 810 indicates 5001 or above points entitles the beneficiary to a $150 cash reward, a 30% discount in services or products, or a free product A or a free product B. It will be appreciated that the above-mentioned rules and rewards are examples only and that other combinations of rewards or ranges are possible.

Referring now to FIG. 9, another example of an approach for operating a private civil security resource is described. At step 902, an indication of a referral is presented to the private civil security loyalty reward program. At step 904, the referral indication is processed and assigned a metric value (e.g., an amount of points). For example, the value of the redeemable rewards metric may be determined by criteria such as the amount the referral (e.g., how many referrals were made by the user), the associated monetary value of the referrals, the nature of services associated with the referrals, or the geographic area associated with the referrals.

At step 906, the reward or rewards are determined. As mentioned elsewhere in this specification, a mapping relationship can be used to determine the reward. And, as mentioned previously, the rewards may include a number of products and/or services such as private civil security subscriptions, private civil security benefits, private civil security products, private civil security services, discounts, cash rewards, promotional products, extensions of time for service memberships, increases in volume of private civil security elements, increases in quality of a private civil security elements, amounts of training, or amounts of instructor-led training. Other examples of rewards are possible.

At step 908, the reward is provided to the authorized beneficiary. For example, the reward may be sent directly by the private civil security loyalty reward program. In another example, the sending of the reward may be facilitated by the program, for instance, by sending instructions to a third party to ship the reward to the authorized beneficiary.

Thus, a private civil security loyalty reward program is provided. This program allows rewards metrics to be accumulated and redeemed for rewards. The private civil security loyalty reward program promotes a higher degree of participation in private civil security products or services. Moreover, the private civil security loyalty reward program is easy and cost effective to use and results in a higher degree of user satisfaction with the private civil security products and services.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method comprising:
providing a private civil security loyalty reward program; and
allowing a user access to the private civil security loyalty reward program.

2. The method of claim 1 further comprising determining whether the user is an authorized beneficiary of the private civil security loyalty reward program and where allowing the user access comprises allowing the user access when the user is an authorized beneficiary.

3. The method of claim 1 further comprising receiving a redeemable rewards metric at the private civil security loyalty reward program from the user.

4. The method of claim 3 wherein the redeemable rewards metric is associated with an external loyalty rewards program.

5. The method of claim 4 wherein the external loyalty rewards program is selected from a group comprising: an airline frequent flier program; a credit card usage program; a retail business loyalty program; a hotel loyalty program; a car rental loyalty program; and a restaurant frequent diner loyalty program.

6. The method of claim 4 further comprising redeeming the redeemable rewards metric at the private civil security loyalty program for at least one private civil security loyalty reward.

7. The method of claim 6 wherein the at least one private civil security loyalty reward comprises at least one reward selected from a group comprising: a private civil security subscription; a private civil security benefit; a private civil security product; a private civil security service; a discount; a cash reward; a promotional product; an extension of time for a service membership; an increase in volume of a private civil security element; an increase in quality of a private civil security element; an amount of training; an amount of instructor-led training.

8. The method of claim 3 wherein receiving a redeemable rewards metric comprises receiving a redeemable rewards metric associated with an interaction of the user with at least one private civil security element.

9. The method of claim 8 wherein the interaction with the private civil security element relates to at least one action selected from a group comprising: a purchase of a private civil security subscription; a purchase of a private civil security benefit; a purchase of a private civil security product; and a purchase of a private civil security service.

10. The method of claim 8 further comprising redeeming the redeemable rewards metric at the private civil security loyalty program for at least one private civil security loyalty reward.

11. The method of claim 10 wherein the at least one private civil security loyalty reward comprises at least one reward selected from a group comprising: a private civil security subscription; a private civil security benefit; a private civil security product; a private civil security service; a discount; a cash reward; a promotional product; and a benefit from an external loyalty rewards program.

12. The method of claim 8 wherein receiving a redeemable rewards metric comprises receiving an indication of an enrollment in a private civil security program training program.

13. The method of claim 12 wherein the private civil security loyalty reward training program provides instructions as how to interact with the at least one private civil security element.

14. The method of claim 13 wherein the instructions are related to at least one training topic area selected from a group comprising: medical assistance skills, food preparation skills, farming skills, botany skills, carpentry skills, communications skills, computer skills, engineering skills, survival skills, nuclear, biological, and chemical threat mitigation skills, transportation skills, evacuation skills, shelter skills, navigation skills, civil defense skills, metal fabrication skills, hunting skills, fishing skills, field dressing of game skills, and business skills.

15. The method of claim 8 wherein receiving a redeemable rewards metric comprises receiving an indication of an initial usage of the at least one private civil security element by the user.

16. The method of claim 15 wherein the redeemable rewards metric for the user is determined based at least in part upon receipts associated with subsequent subscribers as compared to the user.

17. The method of claim 15 further comprising determining whether the user is an initial subscriber based upon at least one criteria selected from a group comprising: a usage of the at least one private civil security element within a predetermined window of time and a maximum aggregate value of receipts associated with subsequent subscriptions.

18. The method of claim 8 wherein receiving a redeemable rewards metric comprises receiving an indication of at least one testimonial made by the user.

19. The method of claim 8 wherein receiving a redeemable rewards metric comprises receiving an indication of at least one referral from the user.

20. The method of claim 19 wherein a value of the redeemable rewards metric is determined by at least one criteria selected from a group comprising: an amount of the at least one referral, an associated monetary value of the at least one referral; a nature of services associated with the at least one referral; and a geographic area associated with the at least one referral.

21. The method of claim 1 further comprising adjusting an amount of the redeemable rewards metric to the user in a time of need.

22. The method of claim 1 further comprising providing a plurality of service levels to the user, the plurality of service levels being associated with the private civil security loyalty reward program.

23. The method of claim 22 wherein the plurality of service levels provided to the user are defined by at least one criteria, the at least one criteria being selected from a group comprising: a monetary payment by the user and a previous usage of the private civil security loyalty reward program by the user.

24. The method of claim 22 wherein each of the plurality of service levels have at least one service associated characteristic selected from a group comprising: a length of service; an amount of available customer support; a quality of service; and a type of service.

25. The method of claim 1 further comprising maintaining information associated with user interaction with the private civil security loyalty reward program in a database.

26. The method of claim 25 further comprising making at least portions of contents of the database available to outside entities.

27. The method of claim 26 wherein the outside entities are selected from a group comprising: an outside corporation, a non-beneficiary individual; a not-for-profit entity; and a government entity.

28. The method of claim 1 wherein the user is not a member of a private civil security network.

29. The method of claim 1 further comprising providing a statement of status to the user.

30. The method of claim 1 further comprising providing a catalog of available services to the user.

31. The method of claim 1 further comprising redeeming the redeemable awards metric for a private civil security membership wherein the redeemable rewards metric is accumulated via an external loyalty rewards program.

32. The method of claim 1 wherein the user can mix and match metrics to obtain one of a plurality of award levels.

33. A method comprising:
receiving a redeemable rewards metric from an external loyalty rewards program;
applying the received redeemable rewards metric to a mapping relationship to obtain at least one private civil security loyalty reward; and
providing the private civil security loyalty reward to an authorized beneficiary.

34. The method of claim 33 wherein the external loyalty rewards program is selected from a group comprising: an airline frequent flier program; a credit card usage program; a retail business loyalty program; a hotel loyalty program; a car rental loyalty program; and a restaurant frequent diner loyalty program

35. The method of claim 33 wherein the at least one private civil security loyalty reward comprises at least one reward selected from a group comprising: a private civil security subscription; a private civil security benefit; a private civil security product; a private civil security service; a discount; a cash reward; and a promotional product.

36. The method of claim 33 wherein the mapping relationship is determined based upon at least one criteria selected from a group comprising: a service level of the authorized beneficiary; an amount of compensation received from the external loyalty rewards program; a value associated with the redeemable rewards metric; a type of service associated with the external loyalty rewards program.

37. A method comprising:
utilizing at least one private civil security element and accumulating a redeemable rewards metric based upon the utilizing;
determining a private civil security loyalty reward based upon the accumulated redeemable rewards metric; and
providing the private civil security loyalty reward to an authorized beneficiary.

38. The method of claim 37 wherein utilizing the at least one private civil security element comprises performing at least one action selected from a group comprising: purchasing a private civil security subscription; purchasing a private civil security benefit; purchasing a private civil security product; and purchasing a private civil security service.

39. The method of claim 37 wherein the at least one private civil security loyalty reward comprises at least one reward selected from a group comprising: a private civil security subscription; a private civil security benefit; a private civil security product; a private civil security service; a discount; a cash reward; a promotional product; an extension of time for a service membership; an increase in volume of a private civil security element; an increase in quality of a private civil security element; an amount of training; an amount of instructor-led training; and a benefit from an external loyalty rewards program.

40. The method of claim 37 wherein utilizing the at least one private civil security element comprises enrolling in a private civil security program training program.

41. The method of claim 40 wherein the private civil security loyalty reward training program provides instructions as how to interact with the at least one private civil security element.

42. The method of claim 41 wherein the instructions are related to at least one training topic area selected from a group comprising: medical assistance skills, food preparation skills, farming skills, botany skills, carpentry skills, communications skills, computer skills, engineering skills, survival skills, nuclear, biological, and chemical threat mitigation skills, transportation skills, evacuation skills, shelter skills, navigation skills, civil defense skills, metal fabrication skills, hunting skills, fishing skills, field dressing of game skills, and business skills.

43. The method of claim 37 wherein utilizing the at least one private civil security element comprises using the at least one private civil security element by the authorized beneficiary during an initial time period.

44. The method of claim 43 wherein the redeemable rewards metric for the authorized beneficiary is determined based at least in part upon receipts associated with subsequent subscribers.

45. The method of claim 43 further comprising determining whether the authorized beneficiary is an initial subscriber based upon at least one criteria selected from a group comprising: a usage of the at least one private civil security element within a predetermined window of time and a maximum aggregate value of receipts associated with subsequent subscriptions.

46. The method of claim 37 wherein utilizing the at least one private civil security element comprises providing at least one testimonial made by the authorized beneficiary.

47. The method of claim 37 wherein utilizing the at least one private civil security element comprises providing at least one referral from the authorized beneficiary.

48. The method of claim 47 wherein a value of the redeemable rewards metric is determined by at least one criteria selected from a group comprising: an amount of the at least one referral, an associated monetary value of the at least one referral; a nature of services associated with the at least one referral; and a geographic area associated with the at least one referral.

49. The method of claim 37 wherein the authorized beneficiary is not a member of a private civil security network.

50. The method of claim 37 further comprising providing a statement of status to the authorized beneficiary.

51. The method of claim 37 further comprising providing a catalog of available services to the authorized beneficiary.

52. The method of claim 37 further comprising redeeming the redeemable awards metric for a private civil security membership wherein the redeemable rewards metric is accumulated via an external loyalty rewards program.

53. A method comprising:
presenting at least one referral made by an authorized beneficiary for a private civil security element;
accumulating a redeemable rewards metric based upon the at least one referral;
determining a private civil security loyalty reward based upon the redeemable rewards metric; and
providing the private civil security loyalty reward to the authorized beneficiary.

54. The method of claim 53 wherein a value of the redeemable rewards metric is determined by at least one criteria selected from a group comprising: an amount of the at least one referral, an associated monetary value of the at least one referral; a nature of services associated with the at least one referral; and a geographic area associated with the at least one referral.

55. The method of claim 53 wherein the at least one private civil security element comprises at least one element selected from a group comprising: a private civil security subscription; a private civil security benefit; a private civil security product; and a private civil security service.

56. The method of claim 53 wherein the at least one private civil security loyalty reward comprises at least one reward selected from a group comprising: a private civil security subscription; a private civil security benefit; a private civil security product; a private civil security service; a discount; a cash reward; a promotional product; an extension of time for a service membership; an increase in volume of a private civil security element; an increase in quality of a private civil security element; an amount of training; an amount of instructor-led training; barter items; and a benefit from an external loyalty rewards program.

57. A system comprising:
a private civil security loyalty reward program;
a database; and
a user interface coupled to the private civil security loyalty reward program and the database, the user interface being adapted to provide an authorized beneficiary with access to and allow interactions with the private civil security loyalty reward program, the private civil security loyalty reward program being configured to store information regarding the interactions of the authorized beneficiary with the private civil security loyalty reward program in the database.

58. The system of claim 57 wherein the interactions comprise presentations of a redeemable rewards metric to the private civil security loyalty reward program.

59. The system of claim 58 wherein the redeemable rewards metric is associated with an external loyalty rewards program.

60. The system of claim 59 wherein the external loyalty rewards program is selected from a group comprising: an airline frequent flier program; a credit card usage program; a retail business loyalty program; a hotel loyalty program; a car rental loyalty program; and a restaurant frequent diner loyalty program.

61. The system of claim 58 wherein the private civil security loyalty reward program is configured to redeem the redeemable rewards metric in order to provide at least one private civil security loyalty reward.

62. The system of claim 61 wherein the at least one private civil security loyalty reward comprises at least one reward selected from a group comprising: a private civil security subscription; a private civil security benefit; a private civil security product; a private civil security service; a discount; a cash reward; and a promotional product.

63. The system of claim 58 wherein the redeemable rewards metric is associated with a usage of at least one private civil security element.

64. The system of claim 63 wherein the at least one private civil security element is selected from a group comprising: a private civil security subscription; a private civil security benefit; a private civil security product; and a private civil security service.

65. The system of claim 63 wherein the private civil security loyalty reward program is configured to redeem the redeemable rewards metric in order to provide at least one private civil security reward.

66. The system of claim 65 wherein the at least one private civil security reward comprises at least one reward selected from a group comprising: a private civil security subscription; a private civil security benefit; a private civil security product; a private civil security service; a discount; a cash reward; a promotional product; an extension of time for a service membership; an increase in volume of a private civil security element; an increase in quality of a private civil security element; an amount of training; an amount of instructor-led training; barter items; and a benefit from an external loyalty rewards program.

67. The system of claim 63 wherein usage of the at least one private civil security element comprises an enrollment in a private civil security program training program.

68. The system of claim 67 wherein the private civil security loyalty reward training program provides instructions as how to interact with the at least one private civil security element.

69. The system of claim 68 wherein the instructions are related to at least one training topic area selected from a group comprising: medical assistance skills, food preparation skills, farming skills, botany skills, carpentry skills, communications skills, computer skills, engineering skills, survival skills, nuclear, biological, and chemical threat mitigation skills, transportation skills, evacuations skills, shelter skills, navigation skills, civil defense skills, metal fabrication skills, hunting skills, fishing skills, field dressing of game skills, and business skills.

70. The system of claim 63 wherein usage of the at least one private civil security element comprises an initial usage of the at least one private civil security element by the authorized beneficiary.

71. The system of claim 70 wherein the redeemable rewards metric for the authorized beneficiary is determined based at least in part upon receipts associated with subsequent subscribers.

72. The system of claim 71 wherein the private civil security loyalty reward program is configured to determine whether the authorized beneficiary is an initial subscriber based upon at least one criteria selected from a group comprising: a usage of the at least one private civil security element within a predetermined window of time and a maximum aggregate value of receipts associated with subsequent subscriptions.

73. The system of claim 63 wherein the usage of the at least one private civil security element comprises at least one testimonial made by the authorized beneficiary.

74. The system of claim 63 wherein the usage of the at least one private civil security element comprises at least one referral from the authorized beneficiary.

75. The system of claim 74 wherein the private civil security loyalty reward program is configured to determine a redeemable rewards metric associated with the at least one referral.

76. The system of claim 75 wherein a value of the redeemable rewards metric is determined by at least one criteria selected from a group comprising: an amount of the at least one referral, an associated monetary value of the at least one referral; a nature of services associated with the at least one referral; and a geographic area associated with the at least one referral.

77. The system of claim 58 wherein the private civil security loyalty reward program is configured to make at least portions of contents of the database available to outside entities.

78. The system of claim 77 wherein the outside entities are selected from a group comprising: an outside corporation, a non-beneficiary individual; a not-for-profit entity; and a government entity.

79. The system of claim 57 wherein the authorized beneficiary is not a member of a private civil security network.

80. The system of claim 57 wherein the private civil security loyalty reward program is configured to provide a statement of status to the authorized beneficiary.

81. The system of claim 57 wherein the private civil security loyalty reward program is configured to provide a catalog of available services to the authorized beneficiary.

82. The system of claim 57 wherein the private civil security loyalty reward program is configured to redeem the redeemable awards metric for a private civil security membership wherein the redeemable rewards metric is accumulated via an external loyalty rewards program.

83. The system of claim 57 further comprising a web interface.

84. The system of claim 83 wherein the web interface performs a function selected from a group comprising: allowing a user to audit information concerning a membership; allowing a user to review account balances; allowing a user to review reward levels; allowing a user to request rewards; allowing a user to ask questions; allowing a user to access a frequently asked question page; allowing a user to enter referral information; allowing a user to perform a management functions.
